(19) United States
(12) Patent Application Publication
(10) Pub. No.: US 2012/0086681 A1
(43) Pub. Date: Apr. 12, 2012

(54) DRIVING APPARATUS AND DISPLAY DIVICE INCLUDING THE SAME

(75) Inventors: Sung Kyun KIM, Seoul (KR); Jung Hong Ahn, Uiwang-si (KR); Sang-Hoon Lee, Uiwang-si (KR)

(73) Assignee: MC Technology Co., Ltd., Suwon-si (KR)

(21) Appl. No.: 13/270,270

(22) Filed: Oct. 11, 2011

(30) Foreign Application Priority Data
Oct. 11, 2010 (KR) 10-2010-0098860
Oct. 10, 2011 (KR) 10-2011-0103180

(51) Int. Cl. G09G 5/00

(52) U.S. Cl. 345/204

(57) ABSTRACT

A liquid crystal display includes a plurality of driving apparatuses one-chipped by including a signal controller controlling a data driver in the data driver applying data voltage to the corresponding data line. Each of the plurality of driving apparatuses includes a first signal terminal and a second signal terminal. The first signal terminal outputs control data for controlling image display to an adjacent signal controller in a first direction for a first period and receives a mode detection signal for determining a final operation mode from the adjacent signal controller in the first direction for a second period after the first period. The second signal terminal outputs the mode detection signal to the adjacent signal controller in a second direction different from the first direction for the first period and receives the control data from the adjacent signal controller in the second direction for the second period.

### CROSS-REFERENCE TO RELATED APPLICATION

This application claims priority to and the benefit of Korean Patent Application No. 10-2010-0098860 and 10-2011-0103180 filed in the Korean Intellectual Property Office on Oct. 11, 2010 and Oct. 10, 2011, the entire contents of which are incorporated herein by reference.

### BACKGROUND OF THE INVENTION

(a) Field of the Invention

The present invention relates to a driving apparatus and a display device including the same. Particularly, the present invention relates to a data driving apparatus of a liquid crystal display having a timing controller and integrated into one-chip.

(b) Description of the Related Art

A liquid crystal has an optical characteristic changed according to the alignment of liquid crystal molecules when light transmits the liquid crystal. A liquid crystal display changes the molecular alignment of the liquid crystal by using the optical characteristic to control the path of light, thereby implementing image display.

The liquid crystal display includes a signal controller for controlling the image display, that is, a timing controller.

The timing controller receives R, G, and B input image signals and input control signals controlling the display thereof from a graphic controller mounted on a computer and the like and processes the R, G, and B input image signals and the input control signals, thereby displaying images. As the R, G, and B input image signals and the input control signals, low voltage differential signals (LVDSs) of which the voltages of the R, G, and B input image signals and the input control signals are lowered by 1V or less are used and in this case, the timing controller performs a function restoring the LVDS to an original state.

Further, for the downsizing and slimness of the liquid crystal display, the timing controller is included in a data driving circuit. That is, the timing controller for controlling the corresponding data driving circuit is included in the data driving circuit and a driving chip integrated with the timing controller by one chip is used. In this case, a plurality of driving chips may be used according to the number of output terminals of the data driving circuit in the liquid crystal display. As describe above, when the plurality of driving chips are used, the LVDS is multi-dropped in each driving chip and the driving chip determines whether to independently operate in a normal mode or a fail mode by using the multi-dropped LVDS and displays the image corresponding to the determined operation mode.

As described above, since each of the driving chips independently determines the operation mode and does not share the determined operation mode, when the fail LVDS is multi-dropped, each driving chip may operate in different operation modes and as a result, different images may be outputted on one display screen. Accordingly, when the plurality of driving chips are used in the display device, a technology in which each driving chip can operate in the same operation mode is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a driving apparatus having advantages of outputting an image corresponding to the same operation mode by each timing controller when a plurality of timing controllers are used.

An exemplary embodiment of the present invention provides a driving apparatus including: a first signal terminal used as an interface of control data for controlling image display; a second signal terminal used as an interface of a mode detection signal corresponding to an operation mode of the image display; and a signal controller setting so as to transmit and receive the control data through the first signal terminal and setting so as to transmit and receive the mode detection signal through the second signal terminal.

The first signal terminal may be used as an input terminal of the control data.

The first signal terminal may include an input terminal of the control data and an output terminal of the control data.

The driving apparatus may further include a sharing terminal transferring a final mode signal corresponding to a final operation mode or used for receiving the final mode signal, in which the signal controller may perform the image display corresponding to the final operation mode.

The driving apparatus may operate as a master or slave, and when the driving apparatus operates as the master, the sharing terminal may be used as an output terminal for transferring the final mode signal, and when the driving apparatus operates as the slave, the sharing terminal may be used as an input terminal for receiving the final mode signal.

The signal controller may determine the operation mode by using the first signal received from an external graphic controller.

The operation mode may be a normal mode or a fail mode.

The driving apparatus may operate as a master or slave, and when the driving apparatus operates as the master, the driving apparatus may receive the mode detection signal of the driving apparatus operating as the slave through the second signal terminal, and when the driving apparatus operates as the slave, the driving apparatus may transfer the its own mode detection signal to the adjacent driving apparatus operating as the slave or the driving apparatus operating as the master through the second signal terminal.

When the driving apparatus operate as the slave and further receives the mode detection signal of the adjacent driving apparatus from the adjacent driving apparatus operating as the slave, the driving apparatus may further transfer the mode detection signal of the adjacent driving apparatus to the driving apparatus operating as the master through the second signal terminal.

When the driving apparatus operates as the master, the driving apparatus may determine the final operation mode in consideration of the mode detection signal of the driving apparatus operating as the master and the mode detection signal received from the driving apparatus operating as the slave.

When the driving apparatus operates as the master, the driving apparatus may determine the final operation mode as the normal mode when both the mode detection signal of the driving apparatus operating as the master and the received mode detection signal correspond to the normal mode.

When the driving apparatus operates as the master, the driving apparatus may determine the final operation mode as the fail mode when at least one of the mode detection signal of the driving apparatus operating as the master and the received mode detection signal corresponds to the fail mode.

Another exemplary embodiment of the present invention provides a driving apparatus including: a signal terminal used as an interface of control data for controlling image display for a first period and used as an interface of a mode detection signal corresponding to an operation mode of the image display for a second period after the first period; and a signal controller setting to transmit and receive the control data through the signal terminal for the first period and setting to transmit and receive the mode detection signal through the signal terminal for the second period, in which the signal terminal is used as an input terminal of the control data for the first period.

The driving apparatus may further include a sharing terminal transferring a final mode signal corresponding to a final operation mode or used for receiving the final mode signal, in which the signal controller may perform the image display corresponding to the final operation mode.

The signal controller may determine the operation mode by using the first signal received from an external graphic controller.

The operation mode may be a normal mode or a fail mode.

The driving apparatus may operate as a master or slave, and when the driving apparatus operates as the master, the signal terminal may be used as an input terminal of the mode detection signal for the second period and,

When the driving apparatus operates as the slave, the signal terminal may be used as an output terminal of the mode detection signal for the second period.

When the driving apparatus operates as the master, the driving apparatus may receive the mode detection signal of the driving apparatus operating as the slave through the signal terminal for the second period and the final operation mode may be determined in consideration of the its own mode detection signal and the mode detection signal received from the driving apparatus operating as the slave.

Yet another exemplary embodiment of the present invention provides a display device including: a plurality of data lines; and a plurality of driving apparatuses including a data driver applying data voltage to the corresponding data line among the plurality of data lines and a signal controller controlling the data driver and formed by one chip together with the data driver, in which the plurality of driving apparatuses are circularly connected to each other and each of the plurality of driving apparatuses includes a first signal terminal used as an interface of control data for controlling image display, a second signal terminal used as an interface of a mode detection signal corresponding to an operation mode of the image display, and a signal controller setting so as to transmit and receive the control data through the first signal terminal and setting so as to transmit and receive the mode detection signal through the second signal terminal.

Each of the plurality of driving apparatuses may further include a sharing terminal transferring a final mode signal corresponding to a final operation mode or used for receiving the final mode signal.

The driving apparatus may receive the control data through the first signal terminal through an inter-integrated circuit (I2C) communication with a memory unit storing the control data.

The plurality of driving apparatuses may generate the mode detection signal by using the first signal received from an external graphic controller, respectively.

Each driving apparatus may operate as a master or slave, and the driving apparatus operating as the master may receive the mode detection signal of the driving apparatus operating as the slave through the second signal terminal and determine a final operation mode in consideration of the its own mode detection signal and the received mode detection signal.

Still another exemplary embodiment of the present invention provides a driving apparatus including: first and second signal terminals used as an interface of control data for controlling image display for a first period and used as an interface of a mode detection signal corresponding to an operation mode of the image display for a second period after the first period; and a signal controller transmitting and receiving the control data through the first and second signal terminals for the first period and transmitting and receiving the mode detection signal through the first and second signal terminals for the second period.

The first signal terminal may be used as an output terminal for transmitting control data to the adjacent signal controller in a first direction for the first period and used as an input terminal for receiving a mode detection signal from the adjacent signal controller in the first direction for the second period and the second signal terminal is used as an output terminal for transferring the mode detection signal to the adjacent signal controller in a second direction different from the first direction for the first period and an input terminal for receiving the control data from the adjacent signal controller in the second direction for the second period.

The first direction may be opposite to the second direction.

The driving apparatus may further include a sharing terminal transferring a final mode signal corresponding to a final operation mode or used for receiving the final operation signal, in which the signal controller may perform the image display corresponding to the final operation mode.

The driving apparatus may operate as a master or slave, when the driving apparatus operates as the master, the sharing terminal may be used as an output terminal for transferring the final mode signal, and when the driving apparatus operates as the slave, the sharing terminal may be used as an input terminal for receiving the final mode signal.

The signal controller may determine the operation mode by using the first signal received from an external graphic controller and output the mode detection signal corresponding to the operation mode through the second signal terminal.

The signal controller may determine a fail mode when the first signal is not normally received.

The first signal may include an input image signal and an input control signal controlling the display of the input image signal.

The first signal may be a low voltage differential signal (LVDS).

The driving apparatus may operate as a master or a slave, the signal controller of the driving apparatus operating as the slave may receive the mode detection signal from the adjacent signal controller in the first direction through the first signal terminal, and output the mode detection signal and the mode detection signal corresponding to the operation mode through the second signal terminal.

The driving apparatus may operate as a master or a slave, and the signal controller of the driving apparatus operating as the master may receive the mode detection signal from the adjacent signal controller in the first direction and determine the final operation mode in consideration of the mode detection signal and the mode detection signal corresponding to the operation mode.

The signal controller of the driving apparatus operating as the master may determine the final operation mode as a normal mode when both the mode detection signal and the mode detection signal corresponding to the operation mode are normal.

The signal controller of the driving apparatus operating as the master may determine the final operation mode as a fail mode when at least one of the mode detection signal and the mode detection signal corresponding to the operation mode is failed.

The driving apparatus may further include a data driver applying data voltage to the corresponding data line according to the control of the signal controller.

The data driver may be one-chipped together with the signal controller.

Still yet another exemplary embodiment of the present invention provides a display device including: a plurality of data lines; and a plurality of driving apparatuses including a data driver applying data voltage to the corresponding data line among the plurality of data lines and a signal controller controlling the data driver and formed by one chip together with the data driver, in which the plurality of driving apparatuses are circularly connected to each other and each of the plurality of driving apparatuses includes a first signal terminal outputting control data for controlling image display to the adjacent signal controller in a first direction for a first period and receiving a mode detection signal for determining a final operation mode from the adjacent signal controller in the first direction for a second period after the first period; and a second signal terminal outputting the mode detection signal to the adjacent signal controller in a second direction different from the first direction for the first period and receiving the control data from the adjacent signal controller in the second direction for the second period.

Each of the plurality of driving apparatuses may further include a sharing terminal transferring a final mode signal corresponding to a final operation mode or used for receiving the final mode signal, in which the sharing terminal may be used as an output terminal for transferring the final mode signal in the driving apparatus operating as the master among the plurality of driving apparatuses and the sharing terminal may be used as an input terminal for receiving the final mode signal transferred from the driving apparatus operating as the master in the driving apparatus operating as the slave among the plurality of driving apparatuses.

The driving apparatus operating as the master may receive the control data through an inter-integrated circuit (I2C) communication with a memory unit storing the control data.

When a rest signal is received, the first period may be performed.

The driving apparatus operating as the master may transfer the control data up to the last driving apparatus through the adjacent driving apparatus in the first direction for the first period in a cascade manner.

The plurality of signal controllers may generate the mode detection signal by using the first signal received from an external graphic controller and output the mode detection signal through the second signal terminal.

The plurality of signal controllers may generate a normal detection signal by the mode detection signal when the first signal is normally received and generate a fail detection signal by the mode detection signal when the first signal is not normally received.

The signal controller of the driving apparatus operating as the slave may receive the mode detection signal from the adjacent signal controller in the first direction through the first signal terminal and output the received mode detection signal and the generated mode detection signal through the second signal terminal.

For the second period, the last driving apparatus may transfer the mode detection signal upto the driving apparatus operating as the master through the adjacent driving apparatus in the second direction in a cascade manner and the driving apparatus operating as the master may determine the final operation mode by using the received mode detection signal and the generated mode detection signal.

The first direction may be opposite to the second direction.

### BRIEF DESCRIPTION OF THE DRAWINGS

FIG. 1 is a schematic diagram illustrating a liquid crystal display according to an exemplary embodiment of the present invention.

FIG. 2 is an equivalent circuit diagram for one pixel of a liquid crystal display according to an exemplary embodiment of the present invention.

FIG. 3 is a schematic diagram illustrating a data driving chip according to an exemplary embodiment of the present invention.

FIGS. 4 and 5 are diagrams illustrating output images according to a normal mode and a fail mode, respectively.

FIG. 6 is a diagram illustrating a data driving chip according to an exemplary embodiment of the present invention.

FIG. 7 is an operation timing diagram of the data driving chip shown in

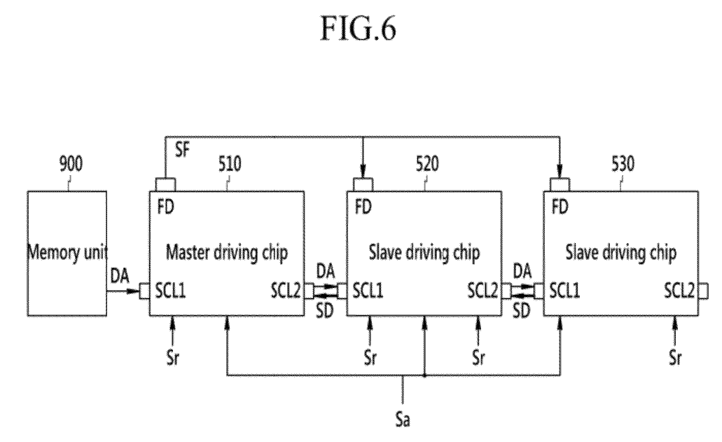

FIG. 6.

FIG. 8 is a diagram illustrating a data driving chip according to an exemplary embodiment of the present invention.

FIG. 9 is a diagram illustrating a data driving chip according to another exemplary embodiment of the present invention.

FIG. 10 is a diagram illustrating a data driving chip according to yet another exemplary embodiment of the present invention.

FIG. 11 is a schematic diagram illustrating an apparatus of controlling transmission of data signals according to an exemplary embodiment of the present invention.

FIG. 12 is a schematic diagram illustrating an apparatus of transmitting and receiving data according to an exemplary embodiment of the present invention.

FIG. 13 is a schematic diagram illustrating an apparatus of controlling synchronization according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification and the overall claims, In addition, unless explicitly described to the contrary, the word “comprise” and variations such as “comprises” or “comprising”, will be understood to imply the inclusion of stated elements but not the exclusion of any other elements.

Hereinafter, a driving apparatus according to an exemplary embodiment of the present invention and a liquid crystal display including the same will be described in detail with reference to the drawings.

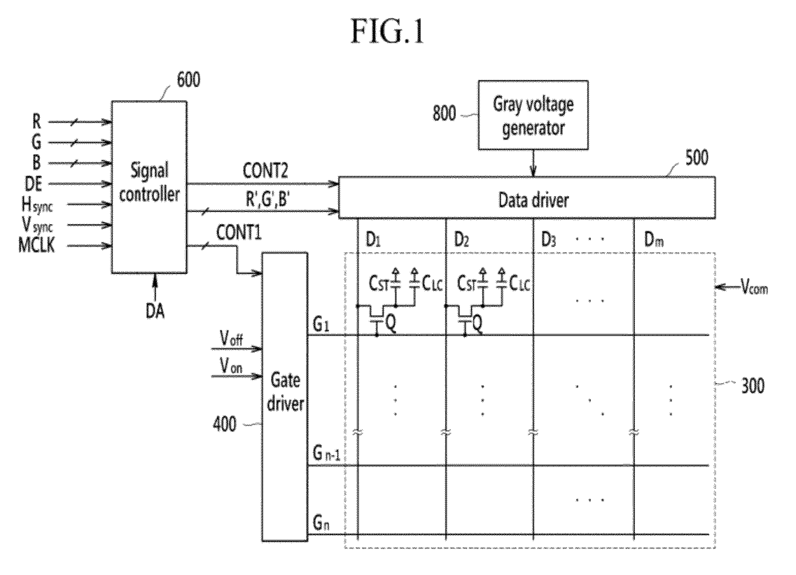

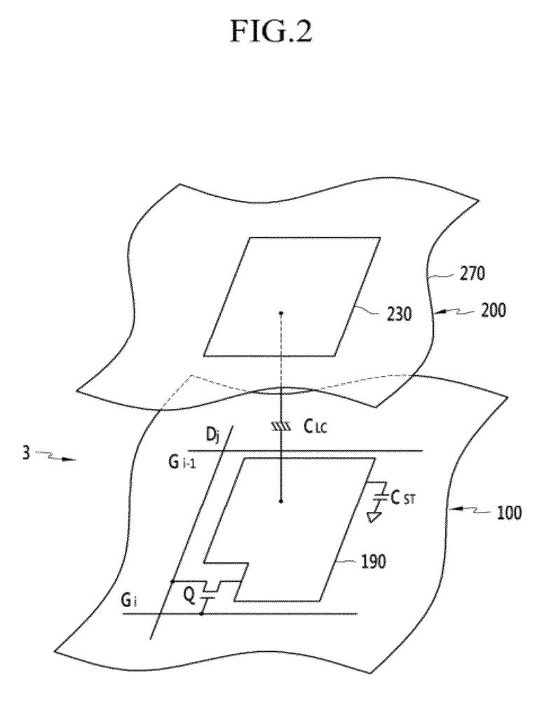

FIG. 1 is a schematic diagram illustrating a liquid crystal display according to an exemplary embodiment of the present invention and FIG. 2 is an equivalent circuit diagram for one pixel of a liquid crystal display according to an exemplary embodiment of the present invention.

Referring to FIG. 1, a liquid crystal display includes a liquid crystal panel assembly 300, a gate driver 400 and a data driver 500 connected to the liquid crystal panel assembly 300, a gray voltage generator 500 connected to the data driver 500, and a signal controller 600 controlling them called a timing controller.

The liquid crystal panel assembly 300 includes a plurality of gate lines G₁-Gₙ transferring gate signals and extending in a row direction, a plurality of data lines D₁-Dₘ transferring data signals corresponding to gray voltage and extending in a column direction, and a plurality of pixels formed in an area where the gate lines G₁-Gₙ and the data lines D₁-Dₘ cross.

Each pixel includes a switching element Q connected to the gate lines G₁-Gₙ and the data lines D₁-Dₘ and a liquid crystal capacitor C_{LC} and a storage capacitor C_{ST} connected to the switching element Q.

Referring to FIG. 2, a control terminal of the switching element Q of one pixel is connected to the gate line Gᵢ, an input terminal thereof is connected to a data line Dⱼ, and an output terminal thereof is connected to one terminal of the liquid crystal capacitor C_{LC} and the storage capacitor C_{ST}.

The liquid crystal capacitor C_{LC} includes a pixel electrode 190 of a lower panel 100 and a common electrode 270 of an upper panel 200 as two terminals and a liquid crystal layer 3 between two electrodes 190 and 270 serves as a dielectric material. The pixel electrode 190 is connected to the switching element Q, the common electrode 270 is formed at the front surface of the upper panel 200, and common voltage V_{com} is applied to the common electrode 270.

The storage capacitor C_{ST} is formed by overlapping a separate signal line (not shown) and the pixel electrode 190 included in the lower panel 100 with an insulator therebetween and the common voltage V_{com} may be applied to the signal line.

Meanwhile, in order to implement color display, each pixel may display colors and the color display can be implemented by including red, green, or blue color filter 230 in a region corresponding to the pixel electrode 190.

Referring back to FIG. 1, the gate driver 400 is connected to the gate lines G₁-Gₒ of the liquid crystal panel assembly 300 and gate signals configured by combining gate on voltage Vₒₙ and gate off voltage V_{off} are applied to the gate lines G₁-Gₙ.

The data driver 500 selects gray voltage from the gray voltage generator 800 and the selected gray voltage is applied to the data lines D₁-Dₘ as a data signal. When the number of output terminals of the data driver 500 connected with the data lines D₁-Dₘ is smaller than the number of the data lines D₁-Dₘ, a plurality of data drivers may be used in the liquid crystal display. For example, when m is 768 and the number of the output terminals of the data driver 500 is 128, six data drivers 500 may be used. Like the data drivers 500, a plurality of gate drivers 400 may be used according to a size of the gate driver 400 in the liquid crystal display.

The signal controller 600 generates control signals controlling operations of the gate driver 400 and the data driver 500 to output the corresponding control signal to the gate driver 400 and the data driver 500.

The data driver 500 among the drivers 400, 500, 600, and 800 and the signal controller 600 are directly mounted on the liquid crystal panel assembly 300 in one integrated circuit chip form (hereinafter, referred to as a data driving chip) or may be mounted on a printed circuit board (PCB). Further, the gray voltage generator 800 may also be mounted on the printed circuit board and the gate driver 400 may be integrated in the liquid crystal panel assembly 300 together with the signal lines G₁-Gₙ and D₁-Dₘ and a thin transistor switching element Q.

Hereinafter, a display operation of the liquid crystal display will be described in more derail.

The signal controller 600 reads control data DA from an external memory unit (not shown) when power is applied to the liquid crystal display.

The control data DA may include output timing data of a gate control signal CONT1 and a data control signal CONT2, instruction data instructing an operation of the liquid crystal display such as dithering or gamma correction, and the like.

Further, the signal controller 600 receives image signals R, G, and B inputted from an external graphic controller (not shown) and input control signals controlling display thereof. For example, the input control signal may be a vertical synchronization signal Vsync, a horizontal synchronization signal Hsync, a main clock MCLK, a data enable signal DE, or the like.

The external graphic controller may convert the image signals R, G, and B and the input control signals into low voltage differential signals LVDSs to transfer the LVDSs to the signal controller 600. In this case, when the plurality of data driver are used, the LVDSs may be multi-dropped in the plurality of data drivers and the signal controller 600 receiving the LVDSs may further include a function of restoring the LVDSs to an original state.

After the signal controller 600 generates the gate control signal CONT1, the data control signal CONT2, and the like by using the input control signals according to the control data DA and processes the image signals R, G, and B in accordance with an operation condition of the liquid crystal panel assembly 300, the signal controller transfers the gate control signal CONT1 to the gate driver 400 and the data control signal CONT2 and the processed image signals R′, G′, and B′ are transferred to the data driver 500.

The gate control signal CONT1 may include a vertical synchronization start signal instructing the output start of a gate-on pulse (for example, a high section of the gate signal), a gate clock signal controlling an output time of the gate-on pulse, and an output enable signal limiting a width of the gate-on pulse.

The data control signal CONT2 may include a horizontal synchronization start signal instructing the input start of the image data R′, G′, and B′, a load signal applying the corresponding data voltage to the data lines D₁-Dₘ, an inversion signal inversing polarity of the data voltage for the common voltage V_{com}, and a data clock signal.

The gray voltage generator 800 generates a plurality of gray voltages relating to the luminance of the liquid crystal display to apply the gray voltages to the data driver 500.

Then, the data driver 500 receives the image data R′, G′, and B′ corresponding to the pixels of one row according to the data control signal CONT2 from the signal controller 600 in sequence and selects the gray voltage corresponding to each of the image data R′, G′, and B′ among the gray voltages from the gray voltage generator 800 to convert the image data R′, G′, and B′ into the corresponding data voltage. In addition, the gate driver 400 applies the gate on voltage Vₒₙ according to the gate control signal CONT1 from the signal controller 600 to the gate lines G₁-Gₙ to turn on the switching element Q connected to the gate lines G₁-Gₙ.

For example, while the gate on voltage Vₒₙ is applied to one gate line Gᵢ and the switching element Q of one row connected thereto is turned on, the data driver 400 supplies each data voltage to the corresponding data line D₁-Dₘ. The data voltage supplied to the data lines D₁-Dₘ is applied to the corresponding pixel through the turned-on switching element Q. A period for which the gate on voltage Vₒₙ is applied to one gate line Gᵢ and then, the switching element Q of one row connected thereto is turned on is called “1H” or “1 horizontal period” and is the same as one period of the horizontal synchronization signal Hsync, the data enable signal DE, and the gate clock signal.

In the manner, the gate one voltage Vₒₙ is applied to all the gate lines G₁-Gₙ for one frame in sequence to apply the data voltage to all the pixels.

One frame ends and then, the next frame starts, and a state of the inversion signal applied to the data driver 500 is controlled so that polarity of the data voltage applied to each pixel is opposite to polarity of the previous frame (“frame inversion”). In this case, the polarity of the data voltage flowing through one data line may be changed according to a characteristic of the inversion signal even in one frame (“line inversion”) or the polarity of the data voltage applied to one pixel row may be different from each other (“dot inversion”).

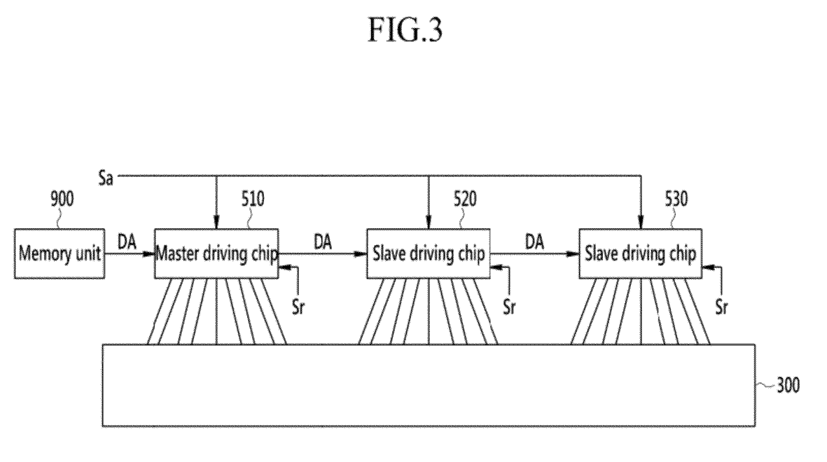

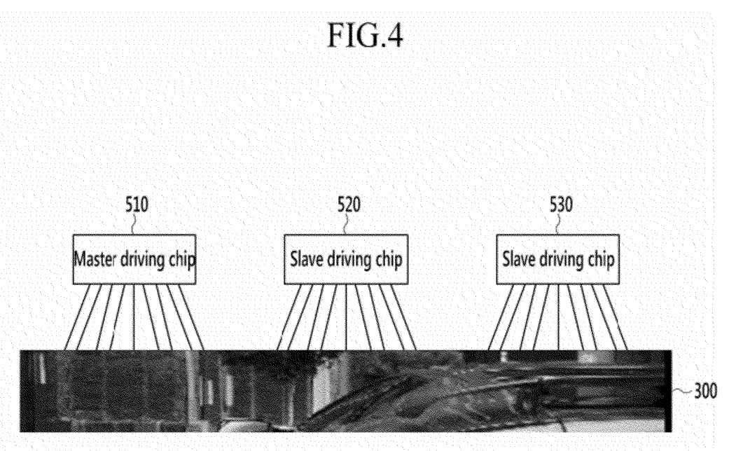

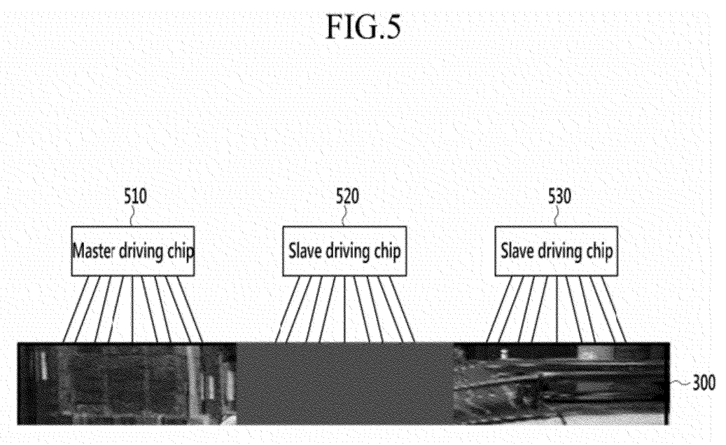

FIG. 3 is a schematic diagram illustrating a data driving chip according to an exemplary embodiment of the present invention and FIGS. 4 and 5 are diagrams illustrating output images according to a normal mode and a fail mode, respectively.

FIGS. 3 to 5 show three data driving chips, but less than or more than three data driving chips may be used according to the number of output terminals connected to the data line. Hereinafter, for convenience of the description, the output terminal connected to the data line will be omitted.

Referring to FIG. 3, data driving chips 510, 520, and 530 are circularly connected to each other and one of the data driving chips 510, 520, and 530 operates as a master and the rest thereof operates as a slave. In this case, one of the data driving chips 510, 520, and 530 may operate as a master according to a chip mode determination signal applied from the outside and the rest thereof may operate as a slave.

A signal controller (600 of FIG. 1) for controlling the data driving chips 510, 520, and 530 may be included in each of the data driving chips 510, 520, and 530. That is, a function of the signal controller for controlling the data driving chips 510, 520, and 530 is performed in the data driving chips 510, 520, and 530.

The data driving chips 510, 520, and 530 are directly mounted on the liquid crystal panel assembly 300 or may be mounted on the printed circuit board (PCB).

In FIG. 3, the data driving chip 510 operates as a master and the data driving chips 520 and 530 operate as a slave, but the data driving chips 510 operating as a master is called a master driving chip 510 and the data driving chips 520 and 530 operating as a slave are called slave driving chips 520 and 530.

If the power is applied to the liquid crystal display, a reset signal Sr is applied to the data driving chips 510, 520, and 530.

The master driving chip 510 among the data driving chips 510, 520, and 530 receiving the reset signal Sr reads the control data DA from a memory unit 900. The master driving chip 510 may perform a communication with the memory unit 900 by using an I2C (Inter-Integrated Circuit) series interface. An EEPROM may be used as the memory unit 900.

The master driving chip 510 may transmit the control data DA up to the last slave driving chip 530 in a cascade manner in which the master driving chip 510 transfers the control data DA to another slave driving chip 530 through adjacent slave driving chip 520.

Further, after the master driving chip 510 successfully reads the control data DA, the slave driving chip 520 may read the control data DA from the memory unit 900 and after the slave driving chip 520 successfully reads the control data DA, the slave driving chip 530 may read the control data DA from the memory unit 900.

Thereafter, the master driving chip 510 and the slave driving chips 520 and 530 receive a signal Sa for driving the liquid crystal panel assembly 300 from the external graphic controller. The signal Sa is multi-dropped to the plurality of data driving chips 510, 520, and 530 by a graphic controller. The image signals R, G, and B and the input control signal controlling the display thereof may be included in the signal Sa and the signal may be a signal converted into the LVDS by the external graphic controller. As described above, when the image signals R, G, and B and input control signal are received to the LVDSs, the master driving chip 510 and the slave driving chips 520 and 530 may include a function of receiving the LVDSs, respectively and restoring the LVDSs to an original signal.

The master driving chip 510 and the slave driving chips 520 and 530 process the signal Sa in accordance with the control data DA. For example, when the control data DA is a command instructing dithering and gamma correction, the master driving chip 510 and the slave driving chips 520 and 530 may output the image signals R, G, and B after the dithering and the gamma correction.

Further, the master driving chip 510 and the slave driving chips 520 and 530 independently determine a normal mode or a fail mode by using the multi-dropped signal Sa and output the image corresponding to the determined mode. For example, when the master driving chip 510 and the slave driving chips 520 and 530 normally receive the multi-dropped signal Sa, it may be determined as the normal mode. If it is determined as the normal mode, the data voltages corresponding to the image signals R′, G′, and B′ are transferred to the corresponding data line. Then, as shown in FIG. 4, the normal image may be displayed in each pixel.

On the contrary, when the multi-dropped signal Sa is not normally received, the master driving chip 510 and the slave driving chips 520 and 530 determine the operation mode as the fail mode and transfers the data voltages corresponding to failed image patterns to the corresponding data line. The failed image patterns may be any predetermined image.

However, since the plurality of data driving chips 510, 520, and 530 independently determine the normal mode and the fail mode and do not share the determined operation mode with each other, when the failed signal Sa is inputted, only some of the plurality of data driving chips 510, 520, and 530 may determine the fail mode. For example, one data driving chip 520 among the plurality of data driving chips 510, 520, and 530 determines the operation mode as the fail mode, as shown in FIG. 5, different images may be displayed on one screen.

Accordingly, a method in which the plurality of data driving chips 510, 520, and 530 operate in the same operation mode will be described in detail with reference to FIGS. 6 to 10.

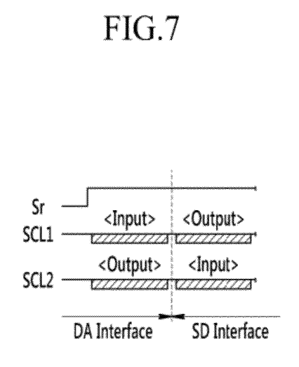

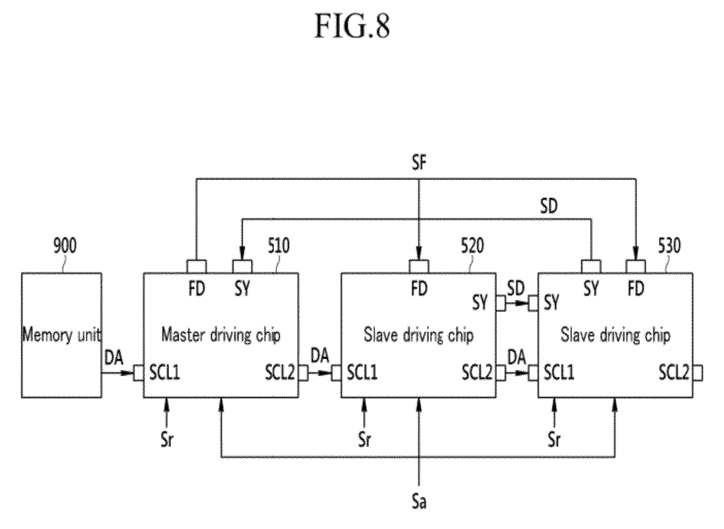

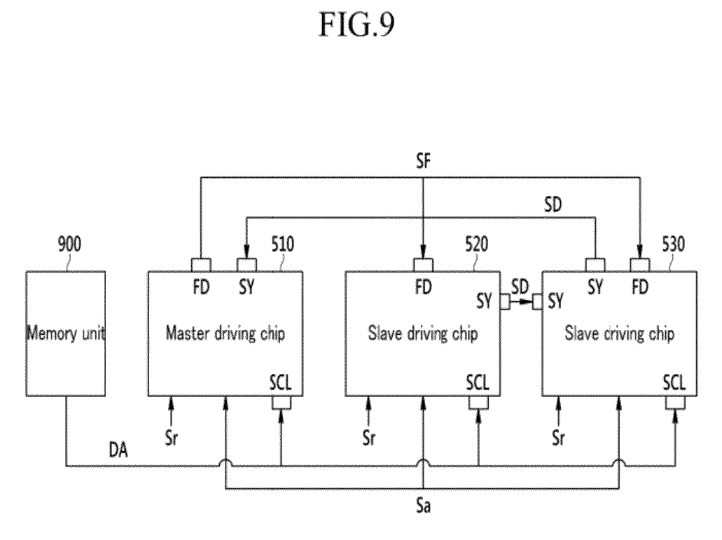

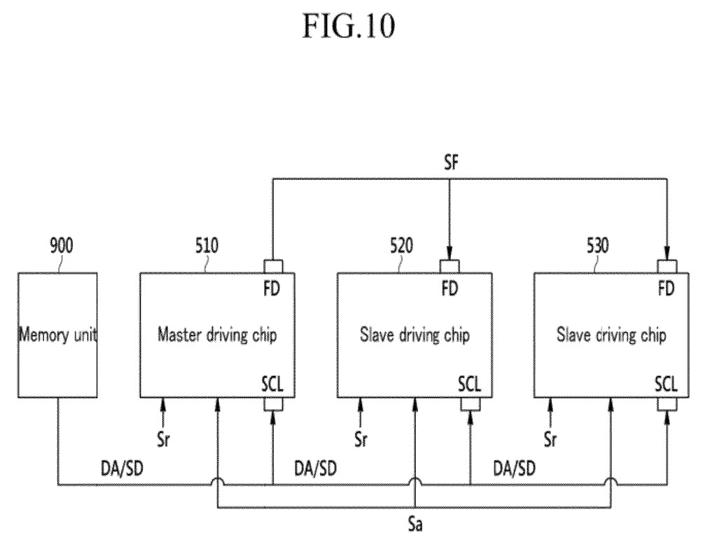

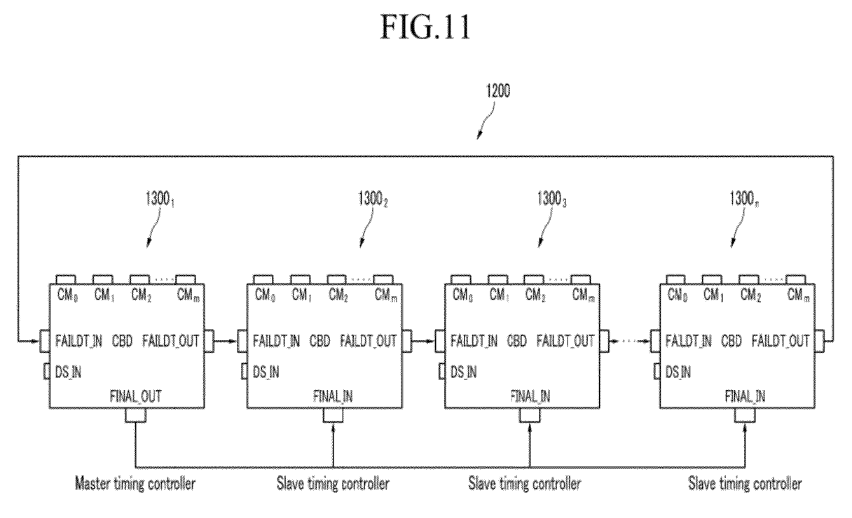

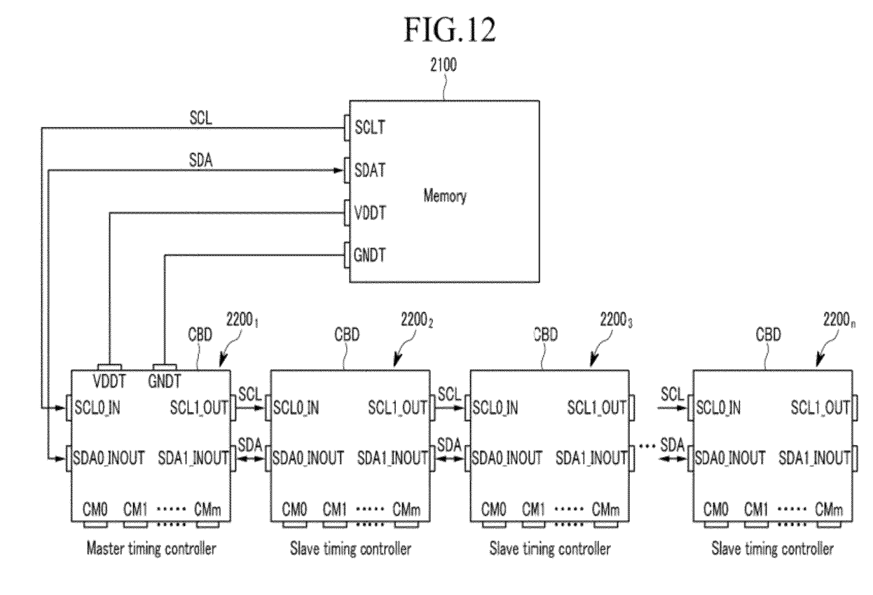

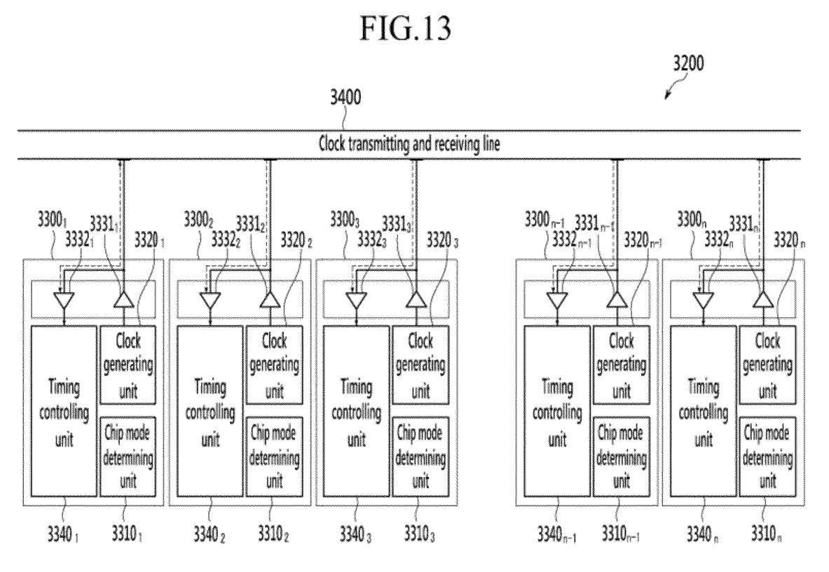

FIG. 6 is a diagram illustrating a data driving chip according to an exemplary embodiment of the present invention and FIG. 7 is an operation timing diagram of the data driving chip shown in FIG. 6.

Referring to FIG. 6, a master driving chip 510′ and slave driving chips 520′ and 530′ have two signal terminals SCL1 and SCL2 and a sharing terminal FD.

The two signal terminals SCL1 and SCL2 are used as an interface of the control data DA and also, as an interface of a mode detection signal SD. When the two signal terminals SCL1 and SCL2 are used as the interface of the control data DA, the signal terminal SCL1 is used as an input terminal of the control data DA and the signal terminal SCL2 is used as an output terminal of the control data DA. On the contrary, when the two signal terminals SCL1 and SCL2 are used as the interface of a mode detection signal SD, the signal terminal SCL1 is used as an output terminal of the mode detection signal SD and the signal terminal SCL2 is used as an input terminal of the mode detection signal SD.

The sharing terminal FD is used as an output terminal of a final mode signal SF in the master driving chip 510 and the sharing terminal FD is used as an input terminal of a final mode signal SF in the slave driving chips 520 and 530.

Referring to FIGS. 6 and 7, when the master driving chip 510 and the slave driving chips 520 and 530 receive the reset signal Sr, the master driving chip 510 connected with the memory unit 900 reads the control data DA from the memory unit 900 through the signal terminal SCL1. The master driving chip 510 reading the control data DA from the memory unit 900 outputs the control data DA to the adjacent slave driving chip 520 through the signal terminal SCL2 and the slave driving chip 520 receives the control data DA through the signal terminal SCL1. Like the master driving chip 510, the slave driving chip 520 outputs control data DA to the adjacent slave driving chip 530 through the signal terminal SCL2 and the slave driving chip 530 receives the control data DA through the signal terminal SCL1. As described above, the last slave driving chip 530 may receive the control data DA.

If the master driving chip 510 and the slave driving chips 520 and 530 normally receive the control data DA, power voltage is maintained and if not so, reference voltage, for example, ground voltage may be maintained.

When the last slave driving chip 530 normally receives the control data DA, the signal terminals SCL1 and SCL2 of the master driving chip 510 and the slave driving chips 520 and 530 are used as the interface of the mode detection signal SD.

That is, the master driving chip 510 and the slave driving chips 520 and 530 determine whether to operate in the normal mode or in the fail mode by using the multi-dropped signal Sa. Further, the master driving chip 510 determines the final operation mode in consideration of the operation mode determined in the master driving chip 510 and the slave driving chips 520 and 530 and transfers the final mode signal SF corresponding to the final operation mode to the slave driving chips 520 and 530 through the sharing terminal FD. Then, the slave driving chips 520 and 530 receive the final mode signal SF through the sharing terminal FD and display the image in the operation mode corresponding to the final mode signal SF.

When the master driving chip 510 determines the final operation mode, in order to consider the operation mode determined in the slave driving chips 520 and 530, the master driving chip 510 should know the operation mode determined by the slave driving chips 520 and 530.

To this end, in the exemplary embodiment of the present invention, the mode detection signal Sa is transferred from the last slave driving chip 530 to the master driving chip 510 through the signal terminals SCL1 and SCL2 in the cascade manner in an opposite direction to a transfer direction of the control data DA.

In detail, since the master driving chip 510 determines the final operation mode, the operation mode is determined in the master driving chip 510 and the slave driving chips 520 and 530 and then, the last slave driving chip 530 transfers the mode detection signal SD according to the its own determining operation mode to the adjacent slave driving chip 520 through the signal terminal SCL1 and the slave driving chip 520 receives the mode detection signal SD of the slave driving chip 530 through the signal terminal SCL2. The slave driving chip 520 which receives the mode detection signal SD of the slave driving chip 530 through the signal terminal SCL2 transfers the mode detection signal SD of the slave driving chip 530 and the mode detection signal SD of the its determining operation mode to the master driving chip 510 through the signal terminal SCL1. When determining the operation mode as the normal mode, the slave driving chips 520 and 530 may output the normal detection signal and in the case of the fail mode, the slave driving chips 520 and 530 may output the fail detection signal.

The master driving chip 510 stands by until the mode detection signal SD of the slave driving chips 520 and 530 is received through the signal terminal SCL2. The master driving chip 510 which receives the mode detection signal SD of the slave driving chips 520 and 530 through the signal terminal SCL2 may determine the final operation mode in consideration of the operation mode corresponding to the mode detection signal SD of the slave driving chips 520 and 530 and the its own judging operation mode. In this case, the master driving chip 510 may determine the final operation mode as the normal mode when both of the mode detection signal SD of the slave driving chips 520 and 530 and the mode detection signal SD of the its own judging operation mode are normal. Further, when at least one of the mode detection signal SD of the slave driving chips 520 and 530 and the mode detection signal SD of the its own judging operation mode is failed, the master driving chip 510 may determine the final operation mode as the fail mode.

Further, the master driving chip 510 transfers the final mode signal SF corresponding to the determined final operation mode to the slave driving chips 520 and 530 through the sharing terminal, such that the master driving chip 510 and the slave driving chips 520 and 530 may display the image in the same operation mode.

As described above, the data driving chips 510, 520, and 530 use the signal terminals SCL1 and SCL2 as the interface of the control data DA in response to the reset signal Sr and thereafter, the signal terminals SCL1 and SCL2 are used as the interface of the mode detection signal, such that the number of the terminals of the data driving chips 510, 520, and 530 may be reduced and the wiring connection may also be simplified.

Meanwhile, the mode detection signal may be transferred from the master driving chip 510 to the slave driving chip 530 through the slave driving chip 520 in the same as the transfer direction of the control data DA. In this case, since the final operation mode is determined by the master driving chip 510, the slave driving chip 530 should transfer the mode detection signal to the master driving chip 620 again. However, like the exemplary embodiment of the present invention, when the mode detection signal is transferred from the last slave driving chip 530 to the master driving chip 510 in an opposite direction to the transfer direction of the control data DA, the wiring connection between the data driving chips 510, 520, and 530 may be further simplified.

FIG. 8 is a diagram illustrating a data driving chip according to an exemplary embodiment of the present invention.

Referring to FIG. 8, the master driving chip 510 and the slave driving chips 520 and 530 have signal terminals SCL1, SCL2, and SY and a sharing terminal FD. The signal terminals SCL1 and SCL2 are used as the interface of the control data DA and the signal terminal SY is used as the interface of the mode detection signal SD. The signal terminals SCL1 of the master driving chip 510 and the slave driving chips 520 and 530 are used as an input terminal of the control data DA and the signal terminals SCL2 are used as an output terminal of the control data DA. The sharing terminal FD of the master driving chip 510 is used as an output terminal of the final mode signal SF and the sharing terminal FD of the slave driving chips 520 and 530 is used as an input terminal of the final mode signal SF.

When the master driving chip 510 and the slave driving chips 520 and 530 receive the reset signal Sr, the master driving chip 510 connected with the memory unit 900 reads the control data DA from the memory unit 900 through the signal terminal SCL1. The master driving chip 510 reading the control data DA from the memory unit 900 output the control data DA to the adjacent slave driving chip 520 through the signal terminal SCL2 and the slave driving chip 520 receives the control data DA through the signal terminal SCL1. Like the master driving chip 510, the slave driving chip 520 outputs the control data DA to the adjacent slave driving chip 530 through the signal terminal SCL2 and the slave driving chip 530 receives the control data DA through the signal terminal SCL1. As described above, the last slave driving chip 530 may receive the control data DA.

After the last slave driving chip 530 normally receives the control data DA, the master driving chip 510 and the slave driving chips 520 and 530 determine whether to operate in the normal mode or the fail mode by using the multi-dropped signal Sa, respectively.

The slave driving chip 520 outputs the mode detection signal SD according to the its own determining operation mode to the adjacent slave driving chip 530 through the signal terminal SY and the slave driving chip 530 receives the mode detection signal SD through the signal terminal SY. In addition, the slave driving chip 530 outputs the mode detection signal SD according to the its own determining operation mode and the mode detection signal SD of the slave driving chip 520 to the master driving chip 510 through the signal terminal SY and the master driving chip 510 receives the mode detection signal SD through the signal terminal SY.

The master driving chip 510 determines the final operation mode in consideration of the operation mode determined by the master driving chip 510 and the slave driving chips 520 and 530. In this case, when both of the mode detection signal SD of the slave driving chips 520 and 530 and the mode detection signal SD of the its own determining operation mode are normal, the master driving chip 510 may determine the final operation mode as the normal mode. In addition, when at least one of the mode detection signal SD of the slave driving chips 520 and 530 and the mode detection signal SD of the its own determining operation mode is failed, the master driving chip 510 may determine the final operation mode as the fail mode. The master driving chip 510 transfers the final mode signal SF corresponding to the final operation mode to the slave driving chips 520 and 530 through the sharing terminal FD. Then, the slave driving chips 520 and 530 receive the final mode signal SF through the sharing terminal FD and display the image in the operation mode corresponding to the final mode signal SF.

In FIG. 8, the interface of the control data DA and the interface of the mode detection signal SD separately operate. Accordingly, problems such as transfer error, electrostatic discharge (ESD), and noise vulnerability, which may be caused when the interface of the control data DA and the interface of the mode detection signal SD are commonly used, may be solved.

FIG. 9 is a diagram illustrating a data driving chip according to another exemplary embodiment of the present invention.

Referring to FIG. 9, the master driving chip 510 and the slave driving chips 520 and 530 have signal terminals SCL and SY and a sharing terminal FD. The signal terminal SCL is used as the interface of the control data DA and the signal terminal SY is used as the interface of the mode detection signal SD. The signal terminals SCL of the master driving chip 510 and the slave driving chips 520 and 530 are used as an input terminal of the control data DA. The sharing terminal FD of the master driving chip 510 is used as an output terminal of the final mode signal SF and the sharing terminal FD of the slave driving chips 520 and 530 is used as an input terminal of the final mode signal SF.

When the master driving chip 510 and the slave driving chips 520 and 530 receive the reset signal Sr, the master driving chip 510 connected with the memory unit 900 reads the control data DA from the memory unit 900 through the signal terminal SCL. If the master driving chip 510 successfully reads the control data DA, the slave driving chip 520 reads the control data DA from the memory unit 900 through the signal terminal SCL. If the slave driving chip 520 successfully reads the control data DA, the slave driving chip 530 reads the control data DA from the memory unit 900 through the signal terminal SCL. As described above, the last slave driving chip 530 may receive the control data DA.

After the last slave driving chip 530 normally receives the control data DA, the master driving chip 510 and the slave driving chips 520 and 530 determine whether to operate in the normal mode or the fail mode operates by using the multi-dropped signal Sa, respectively.

The slave driving chip 520 outputs the mode detection signal SD according to the its own determining operation mode to the adjacent slave driving chip 530 through the signal terminal SY and the slave driving chip 530 receives the mode detection signal SD through the signal terminal SY. In addition, the slave driving chip 530 output the mode detection signal SD according to the its own determining operation mode and the mode detection signal SD of the slave driving chip 520 to the master driving chip 510 through the signal terminal SY and the master driving chip 510 receives the mode detection signal SD through the signal terminal SY.

The master driving chip 510 determines the final operation mode in consideration of the operation mode determined by the master driving chip 510 and the slave driving chips 520 and 530. In this case, when both of the mode detection signal SD of the slave driving chips 520 and 530 and the mode detection signal SD of the its own determining operation mode are normal, the master driving chip 510 may determine the final operation mode as the normal mode. In addition, when at least one of the mode detection signal SD of the slave driving chips 520 and 530 and the mode detection signal SD of the its own determining operation mode is failed, the master driving chip 510 may determine the final operation mode as the fail mode. The master driving chip 510 transfers the final mode signal SF corresponding to the final operation mode to the slave driving chips 520 and 530 through the sharing terminal FD. Then, the slave driving chips 520 and 530 receives the final mode signal SF through the sharing terminal FD and displays the image in the operation mode corresponding to the final mode signal SF.

In FIG. 9, the interface of the control data DA and the interface of the mode detection signal SD separately operate. Accordingly, problems such as transfer error, electrostatic discharge (ESD), and noise vulnerability, which may be caused when the interface of the control data DA and the interface of the mode detection signal SD are commonly used, may be solved. Further, as compared with FIG. 6, since the number of pins is small, a size of the chip is small and an inner logic of the chip is simple, such that the operation is excellent.

FIG. 10 is a diagram illustrating a data driving chip according to yet another exemplary embodiment of the present invention.

Referring to FIG. 10, the master driving chip 510 and the slave driving chips 520 and 530 have signal terminals SCL and a sharing terminal FD. The signal terminals SCL are used as interfaces of the control data DA and the mode detection signal SD. The signal terminals SCL of the master driving chip 510 and the slave driving chips 520 and 530 are used as an input terminal of the control data DA. The signal terminal SCL of the master driving chip 510 is used as an input terminal of the mode detection signal SD and the slave driving chips 520 and 530 are used as an output terminal of the mode detection signal SD. The sharing terminal FD of the master driving chip 510 is used as an output terminal of the final mode signal SF and the sharing terminal FD of the slave driving chips 520 and 530 is used as an input terminal of the final mode signal SF.

When the master driving chip 510 and the slave driving chips 520 and 530 receive the reset signal Sr, the master driving chip 510 connected with the memory unit 900 reads the control data DA from the memory unit 900 through the signal terminal SCL. If the master driving chip 510 successfully reads the control data DA, the slave driving chip 520 reads the control data DA from the memory unit 900 through the signal terminal SCL. If the slave driving chip 520 successfully reads the control data DA, the slave driving chip 530 reads the control data DA from the memory unit 900 through the signal terminal SCL. As described above, the last slave driving chip 530 may receive the control data DA.

After the last slave driving chip 530 normally receives the control data DA, the master driving chip 510 and the slave driving chips 520 and 530 determine whether to operation in the normal mode or the fail mode by using the multi-dropped signal Sa, respectively.

The slave driving chip 520 outputs the mode detection signal SD according to the its own determining operation mode to the master driving chip 510 through the signal terminal SCL and the slave driving chip 530 outputs the mode detection signal SD to the master driving chip 510 through the signal terminal SCL. The master driving chip 510 receives the mode detection signal SD of the slave driving chips 520 and 530 through the signal terminal SCL.

The master driving chip 510 determines the final operation mode in consideration of the operation mode determined by the master driving chip 510 and the slave driving chips 520 and 530. In this case, when both of the mode detection signal SD of the slave driving chips 520 and 530 and the mode detection signal SD of the its own determining operation mode are normal, the master driving chip 510 may determine the final operation mode as the normal mode. In addition, when at least one of the mode detection signal SD of the slave driving chips 520 and 530 and the mode detection signal SD of the its own determining operation mode is failed, the master driving chip 510 may determine the final operation mode as the fail mode. The master driving chip 510 transfers the final mode signal SF corresponding to the final operation mode to the slave driving chips 520 and 530 through the sharing terminal FD. Then, the slave driving chips 520 and 530 receive the final mode signal SF through the sharing terminal FD and display the image in the operation mode corresponding to the final mode signal SF.

Accordingly, the master driving chip 510 and the slave driving chips 520 and 530 may display the image in the same operation mode.

According to the exemplary embodiment of the present invention, in the liquid crystal display, when the timing controller for controlling the corresponding data driving circuit is included in the data driving circuit and the plurality of driving chips one-chipping the timing controller are used, the driving chip operating as a master among the plurality of driving chips receives the mode detection signal of the rest of the driving chips operating as a slave in a cascade manner to determine the final operation mode and then, transfer the final operation mode to the driving chip operating as a slave, such that the plurality of driving chips may display the image in the same operation mode. Further, the timing controller is included in the data driving circuit, such that the liquid crystal display may have a light-weight, low power, and slimness.

In addition, two signal terminals of the plurality of driving chips are used as an interface for transmitting and receiving the control data and used as an interface for transmitting and receiving the mode detection signal, such that the connection wiring among the plurality of driving chips may be simplified.

In addition, the interface of the control data and the interface of the mode detection signal are separately used, such that problems such as the transfer error, the electrostatic discharge (ESD), and noise vulnerability, which may be caused generated when the interface is commonly used, may be solved.

In addition, the number of pins is reduced such that the size of the chip is small and the inner logic of the chip is simple such that a driving apparatus having excellent operation may be acquired.

Meanwhile, another method in which the plurality of data driving chips may operate in the same operation mode will be described in detail with reference to FIG. 11. Hereinafter, a signal controller included in the master driving chip is called a master timing controller and a signal controller included in the slave driving chip is called a slave timing controller.

FIG. 11 is a schematic diagram illustrating an apparatus of controlling transmission of data signals according to an exemplary embodiment of the present invention.

As shown in FIG. 11, a signal transmission controlling apparatus 1200 for controlling the transmission of the data signals according to the exemplary embodiment of the present invention includes a plurality of timing controllers 1300₁-1300ₙ which control operation of a display unit (not shown) and are circularly connected with each other. The signal transmission controlling apparatus 1200 and the display unit according to the exemplary embodiment of the present invention configure the display device to display an image. The plurality of timing controllers 1300₁-1300ₙ include a differential signal input terminal DS_IN, a mode detection input terminal FAILDT_IN, a mode detection output terminal FAILDT_OUT, final mode sharing output terminal FINAL_OUT/final mode sharing input terminal FINAL_IN, a chip mode determining terminal CM0-CMm, and a chip main body CBD. The plurality of timing controllers 1300₁-1300ₙ are set as the master timing controller or the slave timing controller according to a chip mode determining signal applied from the outside through the chip mode determining terminal CM0-CMm. Here, the chip mode determining signal may be a signal which is hard-waredly determined from the outside in order to set the timing controller as the master timing controller or the slave timing controller. In the exemplary embodiment of the present invention, only a timing controller 1300₁ among the plurality of timing controllers 1300₁-1300ₙ is set as a master timing controller 1300₁ and the rest of the timing controllers 1300₂-1300ₙ are set as slave timing controller 1300₂-1300ₙ. The plurality of timing controllers 1300₁-1300ₙ each receive a differential signal from the outside through the differential signal input terminal DS_IN.

The mode detection input terminal FAILDT_IN of the master timing controller 1300₁ is connected to the mode detection output terminal FAILDT_OUT of the slave timing controller 300ₙ and the final mode sharing output terminal FINAL_OUT is connected to the final mode sharing input terminal FINAL_IN of each slave timing controller 1300₂-1300ₙ. In the exemplary embodiment of the present invention, when the master timing controller 1300₁ does not normally receive the differential signal through the differential signal input terminal DS_IN to operate in a fail mode, the master timing controller 1300₁ transfers the signal sharing the fail mode through the final mode sharing output terminal FINAL_OUT to the plurality of slave timing controllers 1300₂-1300ₙ without transferring the signal alarming the fail mode through the mode detection output terminal FAILDT_OUT to each of the slave timing controllers 1300₂-1300ₙ circularly connected to each other. Accordingly, the mode detection output terminal FAILDT_OUT of the master timing controller 1300₁ and the mode detection input terminal FAILDT_IN of the slave timing controller 1300₂ are not connected with each other.

The mode detection output terminal FAILDT_OUT of the slave timing controller 1300₂ is connected to the mode detection input terminal FAILDT_IN of the slave timing controller 1300₃. The final mode sharing input terminal FINAL_IN of the slave timing controller 1300₂ is connected to the final mode sharing output terminal FINAL_OUT of the master timing controller 1300₁.

Similarly, the mode detection input terminals FAILDT_IN of the rest of the slave timing controller 1300₃-1300ₙ are connected to the mode detection output terminal FAILDT_OUT of the adjacent slave timing controller and the final mode sharing input terminal FINAL_IN is connected to the final mode sharing output terminal FINAL_OUT of the master timing controller 1300₁.

Next, a method of sharing an operation mode generated according to the differential signals in the master timing controller 1300₁ and the plurality of slave timing controllers 1300₂-1300ₙ will be described in detail.

First, assuming that the slave timing controller 1300₂ among the plurality of slave timing controllers 1300₂-1300ₙ does not normally receive the differential signal to operate in the fail mode, a method of sharing that the operation mode is the fail mode will be described.

In detail, when the slave timing controller 1300₂ does not normally receive the differential signal through the differential signal input terminal DS_IN to detect that the slave timing controller 1300₂ operates in the fail mode, the slave timing controller 1300₂ generates a fail mode signal in order to alarm the fail mode and transfers the fail mode signal to the mode detection input terminal FAILDT_IN of the adjacent slave timing controller 1300₃ through the mode detection output terminal FAILDT_OUT. The slave timing controller 1300₃ receives the fail mode signal through the mode detection input terminal FAILDT_IN and transfers the received fail mode signal to the mode detection input terminal FAILDT_IN of the adjacent slave timing controller 1300₄ through the mode detection output terminal FAILDT_OUT. In the same method, when the fail mode signal is transferred to the mode detection input terminal FAILDT_IN of the slave timing controller 1300ₙ through the mode detection output terminal FAILDT_OUT of the slave timing controller 1300ₙ₋₁, the slave timing controller 1300ₙ transfers the fail mode signal received through the mode detection output terminal FAILDT_OUT to the mode detection input terminal FAILDT_IN of the master timing controller 1300₁.

When the fail mode signal is transferred from the slave timing controller 1300ₙ, the master timing controller 1300₁ detects that any one of the slave timing controllers 1300₂-1300ₙ operates in the fail mode to generate a fail sharing signal. The master timing controller 1300₁ transfers the fail sharing signal to the plurality of slave timing controllers 1300₂-1300ₙ through the final mode sharing output terminal FINAL_OUT. Simultaneously, the timing controller 1300₁ operates in the fail mode. The plurality of slave timing controllers 1300₂-1300ₙ each receives the fail sharing signal through the final mode sharing input terminal FINAL_IN and simultaneously, operate in the fail mode. That is, the master timing controller 1300₁ and the plurality of slave timing controllers 1300₂-1300ₙ transmit or receive the fail sharing signal and simultaneously, operate in the fail mode.

In the exemplary embodiment of the present invention, one slave timing controller 1300₂ of the plurality of slave timing controllers 1300₂-1300ₙ does not normally receive the differential signal, but the present invention is not limited thereto and even when at least one of the slave timing controllers does not normally receive the differential signal, the slave timing controllers may enter in the fail mode at the same time by applying the same method.

Meanwhile, assuming that the master timing controller 1300₁ does not normally receive the differential signal through the differential signal input terminal DS_IN to operate in the fail mode, the master timing controller 1300₁ detects by itself that the master timing controller 1300₁ operates in the fail mode to generate the fail sharing signal. The master timing controller 1300₁ transfers the fail sharing signal to the plurality of slave timing controllers 1300₂-1300ₙ through the final mode sharing output terminal FINAL_OUT without transferring the fail mode signal to the plurality of slave timing controllers 1300₂-1300ₙ such that all the timing controllers operate in the fail mode at the same time.

As another example, even in the case where the slave timing controller 1300₂ of the plurality of slave timing controllers 1300₂-1300ₙ does not normally receive the differential signal to operate in the fail mode and then, normally receives the differential signal to operate in the normal mode again, if the normal mode signal is transferred to the slave timing controllers circularly connected to each other by the same method and the master timing controller 1300₁ receives the normal modes signal from the slave timing controller adjacent to the master timing controller 1300₁, the master timing controller 1300₁ generates the normal sharing signal for alarming that the operation corresponding to the normal mode is performed to transfer the generated normal sharing signal to the plurality of slave timing controllers 1300₂-1300ₙ at the same time. Meanwhile, even in the case where the master timing controller 1300₁ does not normally receive the differential signal to operate in the fail mode and then, normally receives the differential signal to operate in the normal mode again, the master timing controller 1300₁ transfers the normal sharing signal to the plurality of slave timing controllers 1300₂-1300ₙ through the final mode sharing output terminal FINAL_OUT without transferring the normal mode signal to the plurality of slave timing controllers 1300₂-1300ₙ and shares that all the timing controllers simultaneously operate in the normal mode.

As described above, in the apparatus of controlling the transmission of the data signal including the plurality of timing controllers according to the exemplary embodiment of the present invention, when any one of the plurality of timing controllers operates in the fail mode, as the rest of the timing controllers also share the fail mode and simultaneously, enter in the fail mode, the entire screen may be safely displayed in correct bist patterns at the same time. Herein, the bist patterns are defined image patterns displayed in the case where the plurality of timing controllers operate in the fail mode. By the same method, in the case where any one of the plurality of timing controllers operates in the fail mode and then, operates in the normal mode again, the rest of the timing controllers also share the normal mode, such that the entire screen may be displayed by the image according to the corresponding data signal at the same time.

Meanwhile, the data driving chip and the memory including each timing controller operate in a bus structure of a multi-drop mode based on an I2C bus protocol. In the bus structure of the multi-drop mode, the timing controller initially operates in a slave mode, but when an I2C start signal is not transmitted from the outside for a predetermined time, the timing controller operates in a master mode to be communicated with the memory.

Accordingly, in the bus structure of the multi-drop mode, the plurality of timing controllers operate in the master mode at the same time to perform the I2C communication with the memory. Although any one of the plurality of timing controllers successfully communicates with the memory, the timing controller transmits different response signals ACK concerning whether the data of the memory is normally received to the memory, such that there is a problem in that the I2C communication is not normally performed.

In order to solve the problem, an apparatus of transmitting and receiving data will be described with reference to FIG. 12.

FIG. 12 is a schematic diagram illustrating an apparatus of transmitting and receiving data according to an exemplary embodiment of the present invention.

As shown in FIG. 12, the apparatus of transmitting and receiving data according to the exemplary embodiment of the present invention includes a plurality of timing controllers 2200₁-2200ₙ having the same address as a memory 2100.

The memory 2100 performs the I2C communication with only a timing controller set as a master timing controller among the plurality of timing controllers 2200₁-2200ₙ. In FIG. 12, it is assumed that the timing controller 2200₁ among the plurality of timing controllers 2200₁-2200ₙ is set as the master timing controller 2200₁ to perform the I2C communication with the memory 2100. The memory 2100 includes a first power terminal VDDT, a second power terminal GNDT, a clock terminal SCLT, and a data terminal SDAT. That is, the first power terminal VDDT of the memory 2100 is connected to the first power terminal VDDT of the master timing controller 2200₁ and the second power terminal GNDT is connected to the second power terminal GNDT of the master timing controller 2200₁. The clock terminal SCLT of the memory 2100 is connected to a first clock input terminal SCL0_IN of the master timing controller 2200₁ and the data terminal SDAT is connected to a first data input and output terminal SDA0_INOUT. The memory 2100 supplies power supply VDD required in the driving of the master timing controller 2200₁ through the first power terminal VDDT and transfers a clock signal CLK for synchronization with the master timing controller 2200₁ through the clock terminal SCLT. The memory 2100 transmits and receives data SDA through the data terminal SDAT in synchronization with the master timing controller 2200₁ and the clock signal CLK. Herein, the data SDA includes signals used in the control of the display device, for example, a timing signal, a control signal, and the like.

The plurality of timing controllers 2200₁-2200ₙ include a first clock input terminal SCL0_IN, a second clock output terminal SCL1_OUT, a first data input and output terminal SDA0_INOUT, a second data input and output terminal SDA1_INOUT, a chip mode determining terminal CM0-CMm, and a chip main body CBD. Herein, terminals for supplying the power VDD and GND among the plurality of timing controllers 2200₁-2200ₙ are omitted. The plurality of timing controllers 2200₁-2200ₙ are set as the master timing controller or the slave timing controller according to the chip mode determining signal applied from the outside through the chip mode determining terminal CM0-CMm. Herein, the chip mode determining signal may be a signal which is hard-waredly determined from the outside in order to set the timing controller as the master timing controller or the slave timing controller. In the exemplary embodiment of the present invention, only the timing controller 2200₁ among the plurality of timing controllers 2200₁-2200ₙ is set as the master timing controller 2200₁ and the rest of the timing controllers 2200₂-2200ₙ are set as the slave timing controllers 2200₂-2200ₙ.

The first clock input terminal SCL0_IN of the master timing controller 2200₁ is connected to the clock terminal SCLT of the memory 2100 and the first data input and output terminal SDA0_INOUT is connected to the data terminal.

SDAT of the memory 2100. The second clock output terminal SCL1_OUT of the master timing controller 2200₁ is connected to the first clock input terminal SCL0_IN of the slave timing controller 2200₂ and the second data input and output terminal SDA1_INOUT is connected to the first data input and output terminal SDA0_INOUT of the slave timing controller 2200₂. The second clock output terminal SCL1_OUT of the slave timing controller 2200₂ is connected to the first clock input terminal SCL0_IN of the slave timing controller 2200₃ and the second data input and output terminal SDA1_INOUT is connected to the first data input and output terminal SDA0_INOUT of the slave timing controller 2200₃. Similarly, the first clock input terminals SCL0_IN of the rest of the slave timing controllers 2200₃-2200ₙ are also connected to the second clock output terminal SCL1_OUT of the adjacent slave timing controller and the first data input and output terminal SDA0_INOUT is connected to the second data input and output terminal SDA1_INOUT of the adjacent slave timing controller. That is, the plurality of slave timing controllers 2200₂-2200ₙ are connected to the master timing controller 2200₁ in series.

Next, the transmission and reception of the data SDA in the master timing controller 2200₁ and the plurality of slave timing controllers 2200₂-2200ₙ will be described in detail. The plurality of slave timing controllers 2200₂-2200ₙ according to the exemplary embodiment of the present invention operate in the slave mode in the I2C communication process before receiving the data SDA and operate in the master mode after receiving the data SDA to transfer the data SDA to the adjacent slave timing controller. However, the master timing controller 2200₁ initially operates in the slave mode, but if the I2C communication start signal is not transmitted from the outside for a predetermined time, the master timing controller 2200₁ operates in the master mode by itself to attempt at the communication with the memory 2100.

In detail, the master timing controller 2200₁ uniquely performs the I2C communication with the memory 2100 to receive the data SDA. In detail, the master timing controller 2200₁ receives the clock signal CLK for adjusting the synchronization from the clock terminal SCLT of the memory 2100 through the first clock input terminal SCL0_IN. The master timing controller 2200₁ receives the data SDA from the data terminal SDAT of the memory 2100 through the first data input and output terminal SDA0_IN in synchronization with the clock signal CLK. The master timing controller 2200₁ verifies an error of the data through the check-sum verification of the data SDA when the reception of the data SDA is completed. When the error does not occur, the master timing controller 2200₁ transmits a transmission end signal to the memory 2100 through the first data input and output terminal SDA0_INOUT. When the error occurs, the master timing controller 2200₁ receives the data SDA from the data terminal SDAT of the memory 2100 again. In addition, the master timing controller 2200₁ transmits the received data SDA to the adjacent slave timing controller 2200₂.

The master timing controller 2200₁ according to the exemplary embodiment of the present invention operates in the slave mode in the I2C communication process when the data is received from a device (not shown) other than the memory 2100 through the I2C communication and then, when the communication with the device ends, the master timing controller 2200₁ enters in the master mode to transmit the received data SDA to the adjacent slave timing controller.

The slave timing controller 2200₂ performs the communication with the adjacent master timing controller 2200₁ to receive the data SDA. In detail, the slave timing controller 2200₂ receives the clock signal CLK for adjusting the synchronization from the second clock output terminal SCL1_OUT of the master timing controller 2200₁ through the first clock input terminal SCL0_IN. The slave timing controller 2200₂ receives the data SDA from the second data input and output terminal SDA1_INOUT of the master timing controller 2200₁ through the first data input and output terminal SDA0_INOUT in synchronization with the clock signal CLK. The slave timing controller 2200₂ verifies an error of the data through the check-sum verification of the data SDA when the reception of the data SDA is completed. When the error does not occur, the slave timing controller 2200₂ transmits the transmission end signal to the master timing controller 2200₁ through the first data input and output terminal SDA0_INOUT. When the error occurs, the slave timing controller 2200₂ receives the data SDA from the second data input and output terminal SDA1_INOUT of the master timing controller 2200₁ again. In this case, when the reception of the data SDA is completed without the error, the slave timing controller 2200₂ operates in the master mode to transmit the data SDA to the adjacent slave timing controller 2200₃.

The slave timing controller 2200₃ receives the data SDA from the adjacent master timing controller 2200₂ operating in the master mode. In detail, the slave timing controller 2200₃ receives the clock signal CLK for adjusting the synchronization from the second clock output terminal SCL1_OUT of the slave timing controller 2200₂ through the first clock input terminal SCL0_IN. The slave timing controller 2200₃ receives the data SDA from the second data input and output terminal SDA1_INOUT of the slave timing controller 2200₂ through the first data input and output terminal SDA0_INOUT in synchronization with the clock signal CLK. The slave timing controller 2200₃ verifies an error of the data through the check-sum verification of the data SDA when the reception of the data SDA is completed. When the error does not occur, the slave timing controller 2200₃ transmits the transmission end signal to the slave timing controller 2200₂ through the first data input and output terminal SDA0_INOUT. When the error occurs, the slave timing controller 2200₃ receives the data SDA from the second data input and output terminal SDA1_INOUT of the slave timing controller 2200₂ again.

In the same method, when the reception of the data SDA is completed, the rest of the slave timing controller 2200₄-2200ₙ₋₁ also operate in the master mode in the I2C communication process to transmit the received data SDA to the adjacent slave timing controller operating in the slave mode. In addition, when the data SDA is transmitted up to the last slave timing controller 2200ₙ, the data SDA transmission of the plurality of timing controllers having the same address is completed.

As described above, the master timing controller 2200₁ of the apparatus of transmitting and receiving data according to the exemplary embodiment of the present invention first performs the I2C communication with the memory 2100 one to one to receive the data SDA and transmit the data SDA to the adjacent slave timing controller 2200₂. In this case, when the reception of the data SDA is completed, the slave timing controller 2200₂ operates in the master mode to transmit the data SDA to the next adjacent slave timing controller and transmits the data SDA up to the last slave timing controller 2200ₙ by the same method.

As described above, in the apparatus of transmitting and receiving data based on the multi-drop structure having the same two or more addresses according to the exemplary embodiment of the present invention, the timing controller selected as the master timing controller 2200₁ first performs the I2C communication with the memory 2100 to receive the data SDA and the adjacent slave timing controller 2200₂ among the rest of the slave timing controllers 2200₂-2200ₙ except for the master timing controller 2200₁ receives the data SDA from the master timing controller 2200₁. Thereafter, as the slave timing controller 2200₂ operates in the master mode to transmit the data SDA to the next adjacent slave timing controller again by the same method, the collision between the plurality of timing controllers having the same address may be prevented to normally perform the I2C communication. In addition, the timing controller is set as the master timing controller or the slave timing controller according to the chip mode determining signal applied from the outside every timing controller without change of the I2C bus structure to perform the I2C communication, such that the costs of production for manufacturing a substrate may be reduced. Meanwhile, the plurality of timing controllers include oscillators (not shown), respectively and perform initialization operation by using clock signals generated from the oscillators without using the LVDS in the initial operation. That is, the plurality of timing controllers perform the operation according to the clock signal generated from each built-in oscillator.

As described above, the plurality of timing controllers are included in the same display device to operate, but it is difficult to adjust the synchronization of the clock signal used among the timing controllers by using the different clock signals and accordingly, there is a problem in that the image displayed on the display unit does not properly operate.

In order to solve the problem, the timing controller according to the exemplary embodiment of the present invention for operating the master timing controller and the rest of other timing controllers according to the clock signal generated from the timing controller set as the master timing controller among the plurality of timing controllers and an apparatus of controlling synchronization using the same will be described with reference to FIG. 13.

FIG. 13 is a schematic diagram illustrating an apparatus of controlling synchronization according to an exemplary embodiment of the present invention.

As shown in FIG. 13, an apparatus 3200 of controlling synchronization for controlling the synchronization according to the exemplary embodiment of the present invention includes a plurality of timing controllers 3300₁-3300ₙ and a clock transmitting and receiving line 3400.

The plurality of timing controllers 3300₁-3300ₙ include chip mode determining units 3310₁-3310ₙ, clock generating units 3320₁-3320ₙ, clock transmitting and receiving units 3330₁-3330ₙ, and timing controlling units 3340₁-3340ₙ, respectively. The plurality of timing controllers 3300₁-3300ₙ are set as the master timing controller or the slave timing controller according to a chip mode determining signal applied from the outside through the chip mode determining units 3310₁-3310ₙ, respectively. Herein, the chip mode determining signal may be a signal which is hard-waredly determined from the outside in order to set the timing controller as the master timing controller or the slave timing controller. In the exemplary embodiment of the present invention, it is assumed that only a timing controller 3300₁ among the plurality of timing controllers 3300₁-3300ₙ is set as a master timing controller 3300₁ and the rest of the timing controllers 3300₂-3300ₙ are set as slave timing controllers 3300₂-3300ₙ.

First, the clock generating unit 3320₁ of the master timing controller 3300₁ operates by an oscillator and operates in a clock generation mode in the initial operation of the apparatus of controlling synchronization 3200 to generate a clock signal. In addition, the clock generating unit 3320₁ transfers the generated clock signal to the clock transmitting and receiving unit 3330₁. Herein, the clock generation mode is a mode of generating a clock by activating the corresponding clock generating unit.

The clock transmitting and receiving unit 3330₁ includes a transmitting terminal 3331₁ and a receiving terminal 3332₁. Herein, an input terminal of the transmitting terminal 3331₁ is connected to the clock generating unit 3320₁ and an output terminal thereof is connected to a clock transmitting and receiving line 3400. An input terminal of the receiving terminal 3332₁ is connected between the output terminal of the transmitting terminal 3331₁ and the clock transmitting and receiving line 3400 and an output terminal thereof is connected to the timing controlling unit 3340₁. The transmitting terminal 3331₁ of the clock transmitting and receiving unit 3330₁ operates in the clock transmission mode to transfer the clock signal transferred from the clock generating unit 3320₁ to the clock transmitting and receiving line 3400. Simultaneously, the receiving terminal 3332₁ of the clock transmitting and receiving unit 3330₁ operates in the clock reception mode to transfer the same clock signal as that transferred to the clock transmitting and receiving line 3400 to the timing controlling unit 3340₁. Herein, the clock transmission mode is a mode of transmitting the clock signal to the clock transmitting and receiving line 3400 by activating the corresponding transmitting terminal and the clock reception mode is a mode of transferring the clock signal to the timing controlling unit 3340₁ by activating the corresponding receiving terminal.

The timing controlling unit 3340₁ receives the clock signal through the receiving terminal 3332₁ of the clock transmitting and receiving unit 3330₁. In addition, the timing controlling unit 3340₁ controls the timing used for displaying the image by using the clock signal.

Since the configuration and operation of the rest of the slave timing controllers 3300₂-3300ₙ) according to the exemplary embodiment of the present invention are the same as each other, the configuration and operation thereof will be described in detail by using a slave timing controller 3300₂.

Since the slave timing controller 3300₂ operates by receiving the clock signal generated in the clock generating unit 3320₁ of the master timing controller 3300₁, the clock generating unit 3320₂ operates in a clock non-generation mode not to generate the clock signal. Herein, the clock non-generation mode is a mode in which the corresponding clock generating unit is inactivated not to generate the clock.

The clock transmitting and receiving unit 3330₂ includes a transmitting terminal 3331₂ and a receiving terminal 3332₂. Herein, an input terminal of the transmitting terminal 3331₂ is connected to the clock generating unit 3320₂ and an output terminal thereof is connected to the clock transmitting and receiving line 3400. An input terminal of the receiving terminal 3332₂ is connected between the output terminal of the transmitting terminal 3331₂ and the clock transmitting and receiving line 3400 and an output terminal thereof is connected to the timing controlling unit 3340₂. Since the clock generating unit 3320₂ of the slave timing controller 3300₂ according to the exemplary embodiment of the present invention operates in the clock non-generation mode, the clock signal is not generated and transferred to the clock transmitting and receiving line 3400, but like the transmitting terminal 3331₁ of the master timing controller 3300₁, the clock generating unit 3320₂ is connected with the receiving terminal 3332₂, the clock generating unit 3320₂, and the clock transmitting and receiving line 3400. That is, since the plurality of timing controllers 3300₁-3300ₙ operate as the master timing controller or the slave timing controller according to the chip mode determining signal applied from the outside, an inner connection relationship of each of the timing controllers 3300₁-3300ₙ is equally set.

The timing controlling unit 3340₂ receives the clock signal inputted to the receiving terminal 3332₂ of the clock transmitting and receiving unit 3330₂ through the clock transmitting and receiving line 3400 from the outside. In addition, the timing controlling unit 3340₂ controls the timing used for displaying the image by using the clock signal.

Next, a method of controlling synchronization in the apparatus 3200 of controlling synchronization will be described.

The chip mode determining units 3310₁-3310ₙ of the plurality of timing controllers 3300₁-3300ₙ operate as the master timing controller or the slave timing controller according to the chip mode determining signal applied from the outside, respectively. In the exemplary embodiment of the present invention, the timing controller 3300₁ is set as the master timing controller 3300₁ and the rest of the timing controllers 3300₂-3300ₙ are set as the slave timing controllers 3300₂-3300ₙ.

The clock generating unit 3320₁ of the master timing controller 3300₁ operates in the clock generation mode in the initial operation to generate the clock signal and transfer the generated clock signal to the clock transmitting and receiving unit 3330₁. Then, the transmitting terminal 3331₁ of the clock transmitting and receiving unit 3330₁ operates in the clock transmission mode to receive the clock signal through the input terminal and transfer the clock signal to the clock transmitting and receiving line 3400 through the output terminal. Simultaneously, the receiving terminal 3332₁ of the clock transmitting and receiving unit 3330₁ operates in the clock reception mode to receive the same clock signal as the clock signal transferred to the clock transmitting and receiving line 3400 through the input terminal and transfer the clock signal to the timing controlling unit 3340₁ through the output terminal. The timing controlling unit 3340₁ receives the clock signal through the receiving terminal 3332₁ of the clock transmitting and receiving unit 3330₁ and controls the timing used for displaying the image by using the received clock signal.

Meanwhile, the clock signal transferred to the clock transmitting and receiving line 3400 through the clock transmitting and receiving unit 3330₁ of the master timing controller 3300₁ is transferred to each of the slave timing controllers 3300₂-3300ₙ.

The receiving terminal 3332₂ of the clock transmitting and receiving unit 3330₂ of the slave timing controller 3300₂ operates in the clock reception mode to receive the clock signal from the clock transmitting and receiving line 3400 through the input terminal and transfer the clock signal to the timing controlling unit 3340₂ through the output terminal. In this case, since the clock generating unit 3320₂ of the slave timing controller 3300₂ operates in the clock non-generation mode not to generate the clock signal, the transmitting terminal 3331₂ of the clock transmitting and receiving unit 3330₂ operates in the clock non-generation mode. The timing controlling unit 3340₂ controls the timing used for displaying the image by using the clock signal transferred through the clock transmitting and receiving line 3400. Herein, the clock non-transmission mode is a mode in which the corresponding transmitting terminal is inactivated not to transfer the clock signal to the clock transmitting and receiving line 3400.

The receiving terminal 3332₃ of the clock transmitting and receiving unit 3330₃ of the slave timing controller 3300₃ operates in the clock reception mode to receive the clock signal from the clock transmitting and receiving line 3400 through the input terminal and transfer the clock signal to the timing controlling unit 3340₃ through the output terminal. In this case, since the clock generating unit 3320₃ of the slave timing controller 3300₃ operates in the clock non-generation mode not to generate the clock signal, the transmitting terminal 3331₂ of the clock transmitting and receiving unit 3330₃ operates in the clock non-transmission mode. The timing controlling unit 3340₃ controls the timing used for displaying the image by using the clock signal transferred through the clock transmitting and receiving line 3400.

Similarly, the rest of the slave timing controllers 3300₄-3300ₙ receive the clock signals from the clock transmitting and receiving line 3400 through the input terminals of the receiving terminals 3332₄-3332ₙ of the clock transmitting and receiving units 3330₄-3330ₙ and transfer the clock signal to the timing controlling units 3340₄-3340ₙ through the output terminals. In this case, since the clock generating units 3320₄-3320ₙ of the slave timing controllers 3300₄-3300ₙ operate in the clock non-generation mode not to generate the clock signal, the transmitting terminals 3331₄-3331ₙ of the clock transmitting and receiving units 3330₄-3330ₙ operate in the clock non-transmission mode. The timing controlling units 3340₄-3340ₙ control the timing used for displaying the image by using the clock signals transferred through the clock transmitting and receiving line 3400.

As described above, in the apparatus 3200 of controlling synchronization for controlling the synchronization including the plurality of timing controllers 3300₁-3300ₙ, as the clock signal is generated only in the clock generating unit 3320₁ of the master timing controller 3300₁ among the plurality of timing controllers and the generated clock signal is transferred to the rest of the slave timing controllers 3300₂-3300ₙ through the clock transmitting and receiving line 3400, the synchronization among the plurality of timing controllers 3300₁-3300ₙ may be adjusted by using frequency and phase according to the same clock signal in the driving of the plurality of timing controllers. That is, as the master timing controller 3300₁ and the rest of the slave timing controllers 3300₂-3300ₙ are synchronized and driven by the clock signal generated in the master timing controller 3300₁, the apparatus 3200 of controlling the synchronization operates by one clock signal, such that it is possible to solve a problem caused when displaying the image according a difference of the clock signals.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving apparatus, comprising:
a first signal terminal used as an interface of control data for controlling image display;
a second signal terminal used as an interface of a mode detection signal corresponding to an operation mode of the image display; and
a signal controller setting so as to transmit and receive the control data through the first signal terminal and setting so as to transmit and receive the mode detection signal through the second signal terminal.

2. The driving apparatus of claim 1, wherein:
the first signal terminal is used as an input terminal of the control data.

3. The driving apparatus of claim 1, wherein:
the first signal terminal includes an input terminal and an output terminal of the control data.

4. The driving apparatus of claim 1, further comprising:
a sharing terminal transferring a final mode signal corresponding to a final operation mode or used for receiving the final operation signal,
wherein the signal controller performs the image display corresponding to the final operation mode.

5. The driving apparatus of claim 4, wherein:
the driving apparatus operates as a master or slave, and
when the driving apparatus operates as the master, the sharing terminal is used as an output terminal for transferring the final mode signal, and
when the driving apparatus operates as the slave, the sharing terminal is used as an input terminal for receiving the final mode signal.

6. The driving apparatus of claim 1, wherein:
the signal controller determines the operation mode by using the first signal received from an external graphic controller.

7. The driving apparatus of claim 6, wherein:
the operation mode is a normal mode or a fail mode.

8. The driving apparatus of claim 7, wherein:
the driving apparatus operates as a master or slave, and
when the driving apparatus operates as the master, the driving apparatus receives the mode detection signal of the driving apparatus operating as the slave is received through the second signal terminal, and
when the driving apparatus operates as the slave, the driving apparatus transfers the its own mode detection signal to the adjacent driving apparatus operating as the slave or the driving apparatus operating as the master through the second signal terminal.

9. The driving apparatus of claim 8, wherein:
when the driving apparatus operate as the slave and further receives the mode detection signal of the adjacent driving apparatus from the adjacent driving apparatus operating as the slave, the driving apparatus further transfers the mode detection signal of the adjacent driving apparatus to the driving apparatus operating as the master through the second signal terminal.

10. The driving apparatus of claim 9, wherein:
when the driving apparatus operates as the master, the driving apparatus determines the final operation mode in consideration of the mode detection signal of the driving apparatus operating as the master and the mode detection signal received from the driving apparatus operating as the slave.

11. The driving apparatus of claim 10, wherein:
when the driving apparatus operates as the master, the driving apparatus determines the final operation mode as the normal mode when both the mode detection signal of the driving apparatus operating as the master and the received mode detection signal correspond to the normal mode.

12. The driving apparatus of claim 10, wherein:
when the driving apparatus operates as the master, the driving apparatus determines the final operation mode as the fail mode when at least one of the mode detection signal of the driving apparatus operating as the master and the received mode detection signal correspond to the fail mode.

13. A driving apparatus, comprising:
a signal terminal used as an input interface of control data for controlling image display for a first period and used as an interface of a mode detection signal corresponding to an operation mode of the image display for a second period after the first period; and
a signal controller setting to transmit and receive the control data through the signal terminal for the first period and setting to transmit and receive the mode detection signal through the signal terminal for the second period.

14. The driving apparatus of claim 13, further comprising:
a sharing terminal transferring a final mode signal corresponding to a final operation mode or used for receiving the final mode signal,
wherein the signal controller performs the image display corresponding to the final operation mode.

15. The driving apparatus of claim 13, wherein:
the signal controller determines the operation mode by using the first signal received from an external graphic controller.

16. The driving apparatus of claim 15, wherein:
the operation mode is a normal mode or a fail mode.

17. The driving apparatus of claim 16, wherein:
the driving apparatus operates as a master or slave, and
when the driving apparatus operates as the master, the signal terminal is used as an input terminal of the mode detection signal for the second period and
when the driving apparatus operates as the slave, the signal terminal is used as an output terminal of the mode detection signal for the second period.

18. The driving apparatus of claim 17, wherein:
when the driving apparatus operates as the master, the driving apparatus receives the mode detection signal of the driving apparatus operating as the slave through the signal terminal for the second period and
determines the final operation mode in consideration of the its own mode detection signal and the mode detection signal received from the driving apparatus operating as the slave.

19. A display device, comprising:
a plurality of data lines; and
a plurality of driving apparatuses including a data driver applying data voltage to the corresponding data line among the plurality of data lines and a signal controller controlling the data driver and formed by one chip together with the data driver,
wherein the plurality of driving apparatuses are circularly connected to each other, and
each of the plurality of driving apparatuses includes
a first signal terminal used as an interface of control data for controlling image display;
a second signal terminal used as an interface of a mode detection signal corresponding to an operation mode of the image display; and
a signal controller setting so as to transmit and receive the control data through the first signal terminal and setting so as to transmit and receive the mode detection signal through the second signal terminal.

20. The display device of claim 19, wherein:
each of the plurality of driving apparatuses further includes
a sharing terminal transferring a final mode signal corresponding to a final operation mode or used for receiving the final operation signal.

21. The display device of claim 19, wherein:
the driving apparatus receives the control data through the first signal terminal through an inter-integrated circuit (I2C) communication with a memory unit storing the control data.

22. The display device of claim 19, wherein:
the plurality of driving apparatuses generate the mode detection signal by using the first signal received from an external graphic controller, respectively.

23. The display device of claim 22, wherein:
each of the driving apparatuses operates as a master or slave, and
the driving apparatus operating as the master receives the mode detection signal of the driving apparatus operating as the slave through the second signal terminal and determines a final operation mode in consideration of the its own mode detection signal and the received mode detection signal.

24. A driving apparatus, comprising:
first and second signal terminals used as an input interface of control data for controlling image display for a first period and used as an interface of a mode detection signal corresponding to an operation mode of the image display for a second period after the first period; and
a signal controller transmitting and receiving the control data through the first and second signal terminals for the first period and transmitting and receiving the mode detection signal through the first and second signal terminals for the second period.

25. A display device, comprising:
a plurality of data lines; and
a plurality of driving apparatuses including a data driver applying data voltage to the corresponding data line among the plurality of data lines and a signal controller controlling the data driver and formed by one chip together with the data driver,
wherein the plurality of driving apparatuses are circularly connected to each other,
each of the plurality of driving apparatuses includes
a first signal terminal outputting control data for controlling image display to the adjacent signal controller in a first direction for a first period and receiving a mode detection signal for determining a final operation mode from the adjacent signal controller in the first direction for a second period after the first period; and
a second signal terminal outputting the mode detection signal to the adjacent signal controller in a second direction different from the first direction for the first period and receiving the control data from the adjacent signal controller in the second direction for the second period.
